(19) United States
(12) Patent Application Publication
(10) Pub. No.: US 2005/0266373 A1
(43) Pub. Date: Dec. 1, 2005

(54) Brush structure capable of discharging ozone gases or negative ions (anions)

(76) Inventor: Ching-Fwu Lin, Hsin Chuang City (TW)

Correspondence Address: Ching-Fwu Lin, P.O. Box No. 6-57, Junghe, Taipei, 235, TW

(21) Appl. No.: 10/856,873

(22) Filed: Jun. 1, 2004

(51) Int. Cl. A61C 17/00

(52) U.S. Cl. 433/80

(57) ABSTRACT

The invention discloses to a brush structure capable of discharging beneficial gases or ions. A brush structure according to the invention is capable of discharging human-beneficial gases or ions, which are produced by a gas or ion generating device, guided into an interior of the brush structure using a guide tube, and discharged via a brush head of the brush structure, thereby spontaneously emitting beneficial gases or ions. The brush structure may also be integrated with a vibrating device in an internal cavity of the brush structure to form a brush structure further having motorized massage functions.

### BACKGROUND OF THE INVENTION

(a) Field of the Invention

The invention relates to a brush structure capable of discharging beneficial gases or ions, and more particularly, to a brush structure capable of discharging human-beneficial gases or ions, which are produced by a gas or ion generating device, guided into an interior of the brush structure using a guide tube, and discharged via a brush head of the brush structure, thereby spontaneously emitting beneficial gases or ions. The brush structure may also be integrated with a vibrating device in an internal cavity of the brush structure to form a brush structure further having massage functions.

(b) Description of the Prior Art

Ozone O₃ is a beneficial gas of a natural material having no side-effects of chemical substances, and is capable of pre-sterilizing air and food entering a human body. Even if a virus invades into a human body, using contact between skin and ozone in the air or through breathing, ozone is still reactive by dissolving into water in the skin and drinking water to reach an inner human body, thereby accomplishing disinfection effects. In addition, when ozone is entered into a human body through breathing or via skin pores by contact with the skin when dissolved into water, a high oxygen percentage contained promotes boosting metabolism of various organs and thus reinforcing immune systems, while also providing disinfection, pain relief and anti-inflammation as well as enhancing drying, scarring and regenerating effects.

Furthermore, air that people breathe and depend lives on comprises diverse ions including positive ions (cations) and negative ions (anions). Wherein, negative ions (anions) tend to combine with positive ions (cations) containing moisture and become eliminated, so as to provide dehumidifying effects. Also, negative ions (anions) being micro particles having energies, destroy bacteria or fungi when combined with the bacteria and fungi without further forming any kinds of bacteria, and hence have excellent sterilization effects.

### SUMMARY OF THE INVENTION

The primary object of the invention is to provide a daily-used toothbrush or a beauty brush implementing the aforesaid characteristics and functions of ozone and negative ions (anions). Using an especially devised brush structure, human-beneficial gases or ions are spontaneously discharged when a user utilizes the brush structure for tooth brushing, skin cleansing or environment cleaning, thereby providing tooth cleansing, gum cell vitalizing, skin disinfecting or environment sterilizing effects.

A brush structure according to the invention comprises a hollow cavity, a brush head above the cavity, a plurality of discharge openings at the brush head, and a guide tube pivotally connected to a lower portion of the brush structure. Beneficial gases or ions produced by a gas or ion generating device are forwarded into the brush structure via the guide tube and discharged through the discharge openings, thereby accomplishing tooth cleansing, gum cell vitalizing and regenerating, skin sterilizing and environment cleaning effects.

### BRIEF DESCRIPTION OF THE DRAWINGS

FIG. 1 shows a perspective elevational view according to the invention.

FIG. 2 shows a partial sectional elevational structural view according to the invention.

FIG. 3 shows a sectional structural view according to the invention.

FIG. 4 shows a schematic view illustrating an embodiment according to the invention in use.

FIG. 5 shows a schematic view illustrating an embodiment according to the invention applied to a motorized toothbrush.

### DETAILED DESCRIPTION OF THE PREFERRED EMBODIMENTS

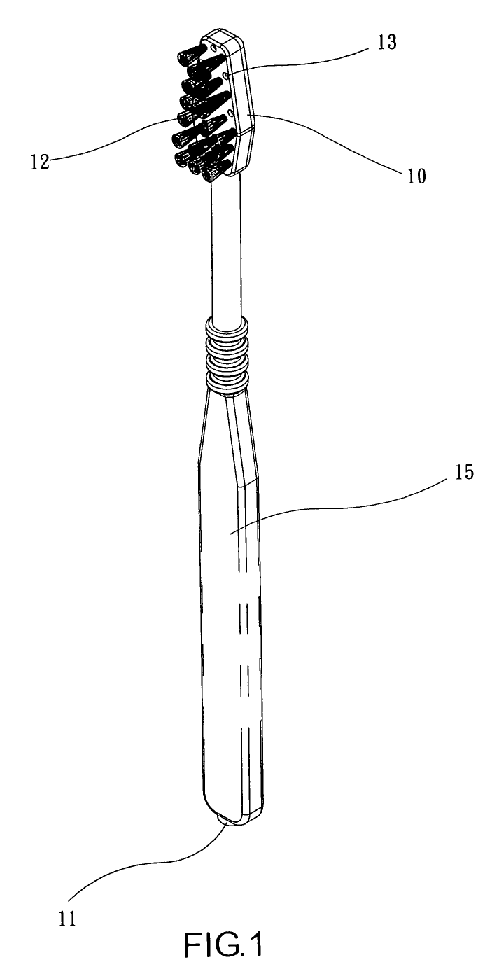

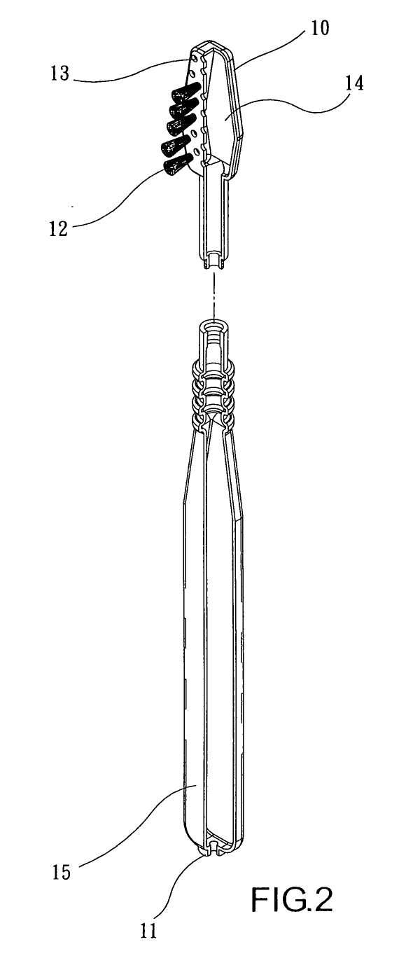

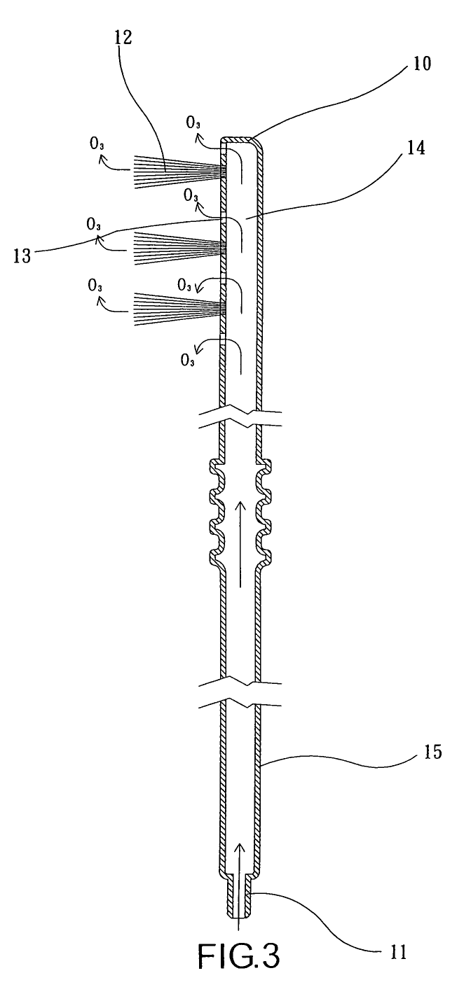

Referring to FIGS. 1, 2, 3 and 4 showing the invention applied to a toothbrush, the brush structure is a hollow cavity having a chamber 14 for accommodating and temporarily storing beneficial gases and ions, and comprises a brush head 10 and a brush handle 15.

The brush head 10 has a plurality of discharge openings 13 devised around brush hair 12 at a center section thereof.

The brush hand 15 has a joint 11 at a lower portion thereof for connecting to a hollow guide tube 16 from an ozone or negative ion (anion) generating device.

To put the aforesaid structure to application, the guide tube 15 from the ozone or negative ion (anion) generating device is connected to the joint 11 of the brush structure. Ozone gases or negative ions (anions) produced by the ozone gas or negative ion (anion) generating device are filled into the chamber 14 of the brush structure via the guide tube 16, and are then discharged through the discharge openings 13 at the brush head 10 or openings at roots of the brush hair 12 to reach an exterior of the brush structure, so as to blend with detergent, toothpaste and water adhered to the brush hair 12 to proceed with tooth brushing, skin cleansing or environment cleaning.

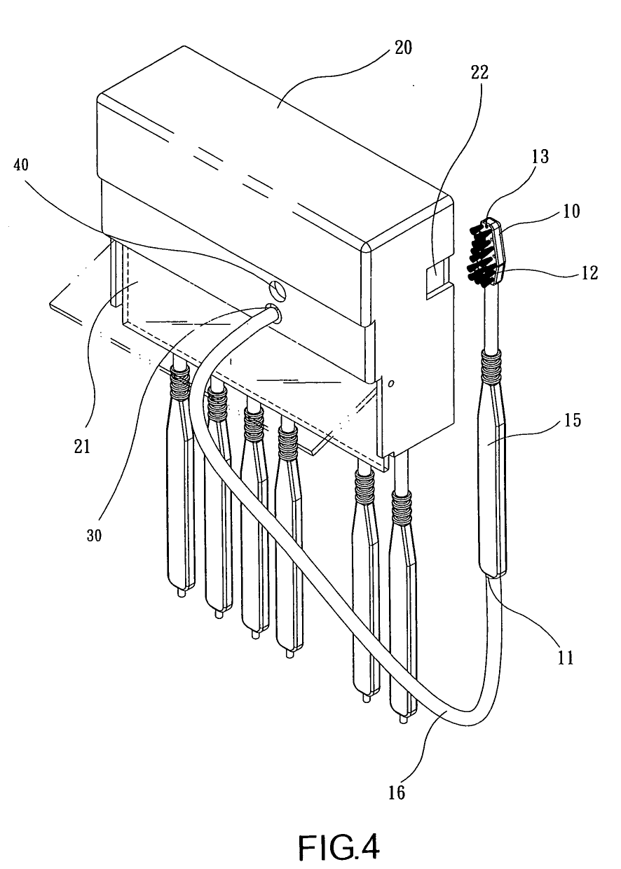

Referring to FIG. 4 again, an ozone or negative ion (anion) generating device attached to the invention comprises a housing 20 having a brush storage rack, a mobile lid 21 that can be lifted or covered at the brush storage rack, and a power socket 22. The housing 20 is provided with an ozone or negative ion (anion) generating device and a pump at an interior thereof; however, the ozone or negative ion (anion) generating device is a prior art and shall not be unnecessarily described. To put the device to use, a power line is inserted into the power socket 22 for power supply, and ozone gases or negative ions (anions) produced by the ozone or negative ion generating device are forwarded using pressures from the pump, entered into the chamber 14 by traveling along the guided tube 16 and through the brush joint 11, and finally discharged through the discharge openings 13 at the brush head 10. Other spare brushes can be stored at the storage rack covered by the mobile lid 21.

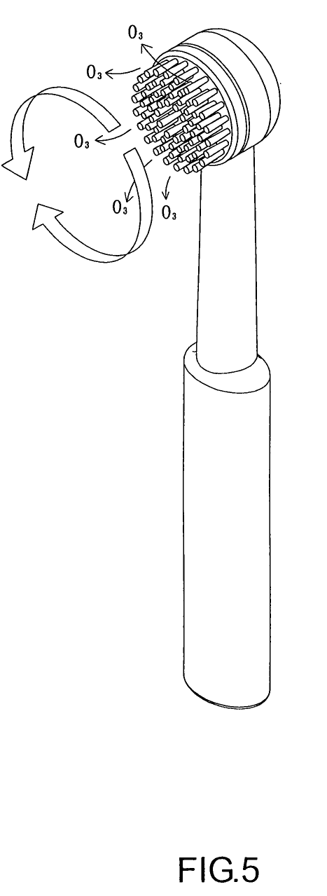

Referring to FIG. 5, the invention can also be integrated with a vibrating device in the chamber of the brush structure to form a brush structure both providing beneficial gases and being a motorized massaging device.

The aforesaid beneficial gas or negative ion (anion) generating device (ozone is adopted as the beneficial gas in the embodiment), is provided with an inlet 40 and an outlet 30. The outlet 30 is joined with the guide tube 16 to pass the ozone gas or the negative ions (anions) to a toothbrush or a beauty brush, whereas the inlet 40 is joined to another guide tube to a cleansing apparatus such as a nose sucking device or a pimple sucking device.

Apart from discharging gases or ions, the brush structure according to the invention may also discharge heating or cooling liquids.

Conclusive from the aforesaid descriptions, the brush structure capable of discharging beneficial gases or ions according to the invention, applies human beneficial gases or ions to healthcare purposes by implementing to a toothbrush or a beauty brush. It is of course to be understood that the embodiment described herein is merely illustrative of the principles of the invention and that a wide variety of modifications thereto may be effected by persons skilled in the art without departing from the spirit and scope of the invention as set forth in the following claims.

1. A brush structure capable of discharging beneficial gases or ions comprising a hollow cavity at a main body thereof, a brush head above the cavity and devised with at least one discharge openings, and a joint at a lower portion thereof for pivotally connecting to a guide tube, such that beneficial gases or ions produced by a gas or ion generating device are forwarded into the brush structure via the guide tube and spontaneously discharged via the discharge openings at the brush head.

2. The brush structure capable of discharging beneficial gases or ions in accordance with claim 1, wherein an inner chamber of the brush structure is provided with a vibrating device to form a brush structure also having functions of a motorized massaging device.

3. The brush structure capable of discharging beneficial gases or ions in accordance with claim 1, wherein the gas or ion generating device comprises a storage rack, a housing having a gas or ion generating device and a pump at an interior thereof, a mobile lid that can be lifted or covered and a power input joint; and
to put the aforesaid structure to use, a power line is connected to a power socket for power supply; and ozone gases or ions produced by the ozone or ion generating device are forwarded using pressures from the pump, entered into the chamber by traveling along the guided tube and through the brush joint, and finally discharged through the discharge openings at the brush head.

4. The brush structure capable of discharging beneficial gases or ions in accordance with claim 3, wherein the gas or ion generating device is provided with an inlet and an outlet; the outlet is joined with the guide tube to pass the ozone gases or ions to a toothbrush or a beauty brush, whereas the inlet is joined to another guide tube to a cleansing apparatus such as a nose sucking device or a pimple sucking device.

5. The brush structure capable of discharging beneficial gases or ions in accordance with claim 1, wherein the brush structure can discharge heating or cooling liquids apart from beneficial gases or ions.
